(19) United States
(12) Patent Application Publication
(10) Pub. No.: US 2025/0259168 A1
(43) Pub. Date: Aug. 14, 2025

(54) INFORMATION PROCESSING DEVICE, INFORMATION PROCESSING SYSTEM, AND INFORMATION PROCESSING METHOD

(71) Applicant: TOSHIBA TEC KABUSHIKI KAISHA, Tokyo (JP)

(72) Inventors: Naoki Ogomori, Mishima Shizuoka (JP); Masahiko Nisiie, Sunto Shizuoka (JP); Yusuke Mimura, Sunto Shizuoka (JP)

(21) Appl. No.: 18/979,697

(22) Filed: Dec. 13, 2024

(30) Foreign Application Priority Data
Feb. 8, 2024 (JP) 2024-017792

(51) Int. Cl. G06Q 20/38; G06Q 20/18; G06Q 20/20

(52) U.S. Cl. CPC G06Q 20/389; G06Q 20/18; G06Q 20/20

(57) ABSTRACT

According to one embodiment, an information processing device includes a status processing unit and a guidance processing unit. The status processing unit sets a status in each of a plurality of transaction processing devices based on an event in each of the plurality of transaction processing devices and a presence or absence result for a user in each of the plurality of transaction processing devices. The guidance processing unit performs processing for showing an available transaction processing device among the plurality of transaction processing devices based on the status in each of the plurality of transaction processing devices.

### CROSS-REFERENCE TO RELATED APPLICATION

This application is based upon and claims the benefit of priority from Japanese Patent Application No. 2024-017792, filed on Feb. 8, 2024, the entire contents of which are incorporated herein by reference.

### FIELD

Embodiments described herein relate generally to an information processing device, an information processing system, and an information processing method.

### BACKGROUND

In recent years, in order to reduce labor costs, the introduction of self-checkout registers, where customers perform operations from registration of products to checkout, has been increasing. Some mass retailers such as supermarkets have gathered all self-checkout registers in one area to set up a checkout area in a store. In the checkout area, customers need to find an available self-checkout register themselves from among a plurality of self-checkout registers. For this reason, when it is crowded at peak times or the like, it takes time for customers to find an available self-checkout register. Thereby, the efficiency of checkout turnover in a store is reduced.

### DESCRIPTION OF THE DRAWINGS

FIG. 1 is a block diagram showing an information processing system according to a first embodiment;

FIG. 2 is a diagram showing an application example of the information processing system;

FIG. 3 is a block diagram showing a guidance terminal;

FIG. 4 is a block diagram showing a POS terminal;

FIG. 5 is a diagram showing a data structure of status data stored in an auxiliary storage device of the guidance terminal;

FIG. 6 is a sequence diagram showing an example of processing performed by a processing circuit of each device included in the information processing system;

FIG. 7 is a sequence diagram showing an example of processing performed by the processing circuit of each device included in the information processing system;

FIG. 8 is a sequence diagram showing an example of processing performed by the processing circuit of each device included in the information processing system;

FIG. 9 is a flowchart showing an example of processing performed by the processing circuit of the guidance terminal;

FIG. 10 is a diagram showing a display example of a guidance screen displayed on a display device of the guidance terminal;

FIG. 11 is a diagram showing a display example of an input information selection screen displayed on the display device of the guidance;

FIG. 12 is a diagram showing a display example of a language selection screen displayed on the display device of the guidance terminal;

FIG. 13 is a diagram showing a display example of a purchase necessity selection screen for a paid bag, which is displayed on the display device of the guidance terminal;

FIG. 14 is a diagram showing a display example of a quantity input screen displayed on the display device of the guidance terminal;

FIG. 15 is a block diagram showing an information processing system according to a second embodiment; and

FIG. 16 is a block diagram showing a server according to the second embodiment.

### DETAILED DESCRIPTION

The problem to be solved by the embodiments is to provide a technique that enables guidance to an available transaction processing device among a plurality of transaction processing devices.

In general, according to one embodiment, an information processing device includes a status processing unit and a guidance processing unit. The status processing unit sets a status in each of a plurality of transaction processing devices based on an event in each of the plurality of transaction processing devices and a presence or absence result for a user in each of the plurality of transaction processing devices. The guidance processing unit performs processing for guiding to an available transaction processing device among the plurality of transaction processing devices based on the status in each of the plurality of transaction processing devices.

Below, several embodiments will be described with reference to the drawings. The scale of each part may be changed as appropriate in each drawing used to describe the following embodiments. In addition, for the sake of description, a configuration may be omitted in each drawing used to describe the following embodiments.

### First Embodiment

### Configuration Example

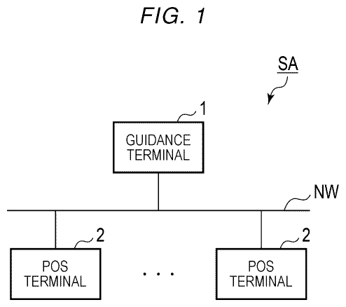

FIG. 1 is a block diagram showing an example of an information processing system SA.

The information processing system SA is a system that performs communication between a plurality of devices and supports transactions in a store. For example, the store may be a mass retailer such as a supermarket, but is not limited thereto. A transaction is the transfer of a cost from a customer to a store associated with the sale of a product by the store. From the perspective of the store, a transaction includes the sale of a product. From the perspective of the customer, a transaction includes the purchase of a product. Products include not only objects, but also other objects, such as services or tickets, which are not tangible. Unless otherwise specified, the term “transaction” refers to the same transaction. A customers includes the meaning of a user.

The information processing system SA includes one guidance terminal 1 and a plurality of Point of Sales (POS) terminals 2. The guidance terminal 1 and the plurality of POS terminals 2 are installed in a store. The guidance terminal 1 and the plurality of POS terminals 2 are connected to each other via a network NW so as to be able to communicate with each other. The network NW is a local area network (LAN) or the like. The LAN may be a wireless LAN or a wired LAN.

The guidance terminal 1 is a device for showing, to a customer, an available POS terminal 2 among the plurality of POS terminals 2. The guidance terminal 1 may be a device such as a smartphone, a tablet terminal, or a personal computer (PC) or may be a dedicated device. The guidance terminal 1 is an example of an information processing device.

The POS terminal 2 is a device that processes transactions in the store. Here, the POS terminal 2 is a POS terminal that has a product registration function and a checkout function, and allows customers to register products and perform checkout without the involvement of a store clerk. The POS terminal 2 is an example of a transaction processing device.

Product registration is the registration of products to be transacted before checkout for a transaction. Registered products are also referred to as registered products. Checkout is payment for a transaction. Checkout includes the meaning of settlement. Checkout methods for checkout for a transaction include offline settlement and online settlement. The offline settlement is a checkout method that does not require the POS terminal 2 to be associated with other devices via a network such as the Internet. For example, the offline settlement is checkout using cash and cash vouchers. The cash vouchers are certificates that are circulated in a form similar to cash currency. For example, the cash vouchers are gift certificates, gift vouchers, shareholder coupons, coupons, and the like, but are not limited thereto. The online settlement is checkout that is executed by the POS terminal 2 in association with other devices via a network such as the Internet. For example, the online settlement is credit card settlement, electronic money settlement, debit card settlement, code settlement, and the like.

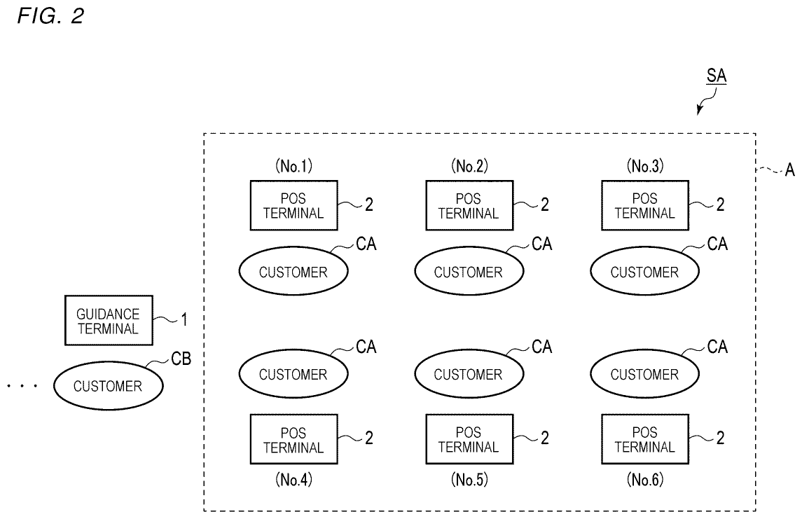

FIG. 2 is a diagram showing an application example of the information processing system SA.

Here, six POS terminals 2 are installed as the plurality of POS terminals 2 in a checkout area A of the store. Number of No. 1 to No. 6 are pieces of terminal identification information that are allocated to the POS terminals 2 and make it possible to uniquely identify the POS terminals 2. Six customers CA use the respective six POS terminals 2.

A guidance terminal 1 is installed at the entrance of the checkout area A. When there is no available POS terminal 2 among the six POS terminals 2, one or more customers CB wait in turn near the guidance terminal 1 for any POS terminal 2 to become available.

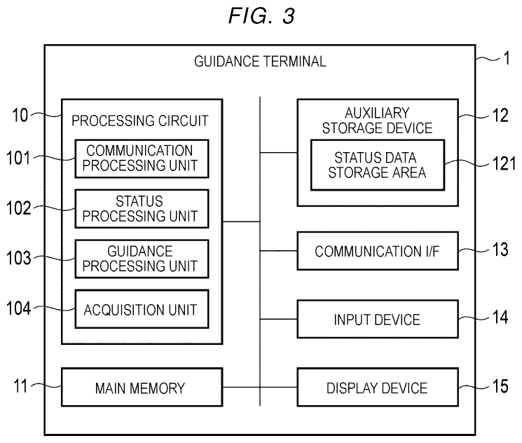

FIG. 3 is a block diagram showing an example of the guidance terminal 1.

The guidance terminal 1 includes a processing circuit 10, a main memory 11, an auxiliary storage device 12, a communication interface 13, an input device 14, and a display device 15. In FIG. 3, an interface is referred to as “I/F”.

The processing circuit 10 is equivalent to the central part of the guidance terminal 1. The processing circuit 10 is an element that constitutes a computer of the guidance terminal 1. The processing circuit 10 includes one or more circuits that execute a plurality of processes by a plurality of functions. For example, the circuit is a processor, an application specific integrated circuit (ASIC), or a field-programmable gate array (FPGA), but is not limited thereto. For example, the processor is a CPU (central processing unit) or a GPU (graphics processing unit), but is not limited thereto. The processing circuit 10 loads a program that is previously stored in the main memory 11 or the auxiliary storage device 12 into the main memory 11. The program is a program that can cause the processing circuit 10 to execute processing by each unit to be described below. The processing circuit 10 executes the program loaded into the main memory 11, thereby enabling various processes to be executed.

The main memory 11 includes elements equivalent to main memory portions of the guidance terminal 1. The main memory 11 is an element that constitutes the computer of the guidance terminal 1. The main memory 11 includes a non-volatile memory area and a volatile memory area. The main memory 11 stores an operating system or a program in the non-volatile memory area. The main memory 11 uses the volatile memory area as a work area where data is appropriately rewritten by the processing circuit 10. For example, the main memory 11 includes a read only memory (ROM) as a non-volatile memory area. For example, the main memory 11 includes a random access memory (RAM) as a volatile memory area. The main memory 11 is an example of a storage unit of the guidance terminal 1.

The auxiliary storage device 12 is equivalent to an auxiliary storage portion of the guidance terminal 1. The auxiliary storage device 12 includes one or more storage devices. The storage device may be an electric erasable programmable read-only memory (EEPROM) (registered trademark), a hard disc drive (HDD), a solid state drive (SSD), or a flash memory, but is not limited thereto. The auxiliary storage device 12 stores the above-mentioned programs, data used by the processing circuit 10 to perform various processes, and data generated by the processing in the processing circuit 10. The auxiliary storage device 12 is an example of a storage unit of the guidance terminal 1.

The auxiliary storage device 12 includes a status data storage area 121. The status data storage area 121 stores status data of each of the plurality of POS terminals 2. The status data is data regarding the status of the POS terminal 2. The status of the POS terminal 2 is the usage status of the POS terminal 2. The usage status is either in-use state or available state.

In-use state is a status in which a customer is using the POS terminal 2. The expression “in-use state” includes the meaning that the POS terminal 2 cannot be used by a customer waiting for any POS terminal 2 to become available, or that the POS terminal 2 is not available. A POS terminal 2 whose status is in-use state is a POS terminal 2 that cannot be used or is not available for a customer waiting for any POS terminal 2 to become available. When the status of a POS terminal 2 is in-use state, a customer waiting for a POS terminal 2 to become available cannot use this POS terminal 2.

Available state is a status in which a customer is not using the POS terminal 2. The expression “available state” includes the meaning that a POS terminal 2 can be used by a customer waiting for any POS terminal 2 to become available, or that the POS terminal 2 is not in in-use state. A POS terminal 2 whose status is available state is an available POS terminal 2. An available POS terminal 2 is a POS terminal 2 that can be used or is not in in-use state by a customer waiting for any POS terminal 2 to become available. When the status of a POS terminal 2 is available, a customer waiting for any POS terminal 2 to become available can use this POS terminal 2.

Here, an example in which the auxiliary storage device 12 stores the status data of each of the plurality of POS terminals 2 is described, but this is not limiting. The main memory 11 may store the status data of each of the plurality of POS terminals 2.

The communication interface 13 includes various interfaces that connect the guidance terminal 1 to other devices via the network NW in accordance with a predetermined communication protocol. The communication interface 13 is an example of a communication unit of the guidance terminal 1.

The input device 14 is a device that can input instructions or information to the guidance terminal 1. The input device 14 may include a keyboard. The input device 14 may constitute a touch screen together with the display device 15. The input device 14 is an example of an input unit of the guidance terminal 1.

The display device 15 is a device that can display various images under the control of the processing circuit 10. For example, the display device 15 is a liquid crystal display, an electroluminescence (EL) display or the like. The display device 15 is an example of the display unit of the guidance terminal 1.

The hardware configuration of the guidance terminal 1 is not limited to the above-mentioned configuration. The guidance terminal 1 allows the above-mentioned components to be omitted or modified and new components to be added as appropriate.

Each unit realized by the processing circuit 10 will be described.

The processing circuit 10 realizes a communication processing unit 101, a status processing unit 102, a guidance processing unit 103, and an acquisition unit 104. Each unit realized by the processing circuit 10 can also be referred to as a function. Each unit realized by the processing circuit 10 can also be referred to as being realized by a control unit including the processing circuit 10 and the main memory 11.

The communication processing unit 101 communicates with other devices via the communication interface 13.

The status processing unit 102 sets the status in each of the plurality of POS terminals 2. Setting the status includes setting the status to an in-use state. Setting the status to an in-use state includes changing the status from an available state to an in-use state. Setting the status includes setting the status to an available state. Setting the status to an available state includes changing the status from an in-use state to an available state.

The guidance processing unit 103 executes processing related to guidance to an available POS terminal 2 among the plurality of POS terminals 2.

The acquisition unit 104 acquires instructions or

information input in response to a customer's operation on the input device 14.

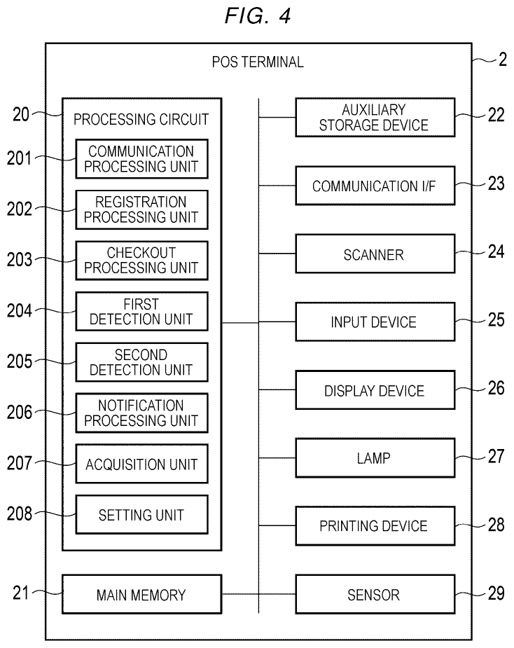

FIG. 4 is a block diagram showing the POS terminal 2.

The POS terminal 2 includes a processing circuit 20, a main memory 21, an auxiliary storage device 22, a communication interface 23, a scanner 24, an input device 25, a display device 26, a lamp 27, a printing device 28, and a sensor 29. The processing circuit 20, the main memory 21, the auxiliary storage device 22, the communication interface 23, the scanner 24, the input device 25, the display device 26, the lamp 27, the printing device 28, and the sensor 29 are connected to each other so that signals can be input and output. In FIG. 4, the interface is referred to as “I/F”.

The processing circuit 20 is equivalent to the central part of the POS terminal 2. The processing circuit 20 is an element that constitutes the computer of the POS terminal 2. Similarly to the processing circuit 10, the processing circuit 20 includes one or more circuits that execute a plurality of processes by a plurality of functions. The processing circuit 20 loads a program that is previously stored in the main memory 21 or the auxiliary storage device 22 into the main memory 21. The program is a program that can cause the processing circuit 20 to execute a process by each unit to be described below. The processing circuit 20 executes the program loaded into the main memory 21, thereby enabling various processes to be executed.

The main memory 21 includes elements equivalent to main memory portions of the POS terminal 2. The main memory 21 is an element that constitutes the computer of the POS terminal 2. The main memory 21 may be configured in the same manner as the main memory 11. The main memory 21 is an example of a storage unit of the POS terminal 2.

The auxiliary storage device 22 is equivalent to an auxiliary storage portion of the POS terminal 2. The auxiliary storage device 22 includes one or more storage devices, similar to the auxiliary storage device 12. The auxiliary storage device 22 is an example of a storage unit of the POS terminal 2.

The auxiliary storage device 22 can store product master data. The product master r data includes product information for each product handled in a store. The product information can include a product code, a product name, and a price. The product code is identification information for uniquely identifying a product. The product name is the name of the product. The price is the unit price indicating the amount of money for each product. The product information may include information other than the above-mentioned information.

The communication interface 23 includes various interfaces that connect the POS terminal 2 to other devices via the network NW in accordance with a predetermined communication protocol. The communication interface 23 is an example of a communication unit of the POS terminal 2.

The scanner 24 is a device that reads various code symbols and acquires information from the code symbols. For example, the code symbol is a barcode symbol or a two-dimensional code symbol. The code symbol may include a code symbol of a product having a product code recorded thereon. The code symbol of the product is an image attached to the product. The code symbol may include a code symbol having a membership code recorded thereon. The code symbol having the membership code recorded thereon may be an image attached to a membership card or an image that can be displayed on a terminal. The code symbol may include a code symbol for code settlement. The scanner 24 is an example of a reading unit of the POS terminal 2.

The input device 25 is a device that can input instructions or information to the POS terminal 2. The input device 25 may include a keyboard. The input device 25 may constitute a touch screen together with the display device 26. The input device 25 is an example of an input unit of the POS terminal 2.

The display device 26 is a device capable of displaying various images under the control of the processing circuit 20. The display device 26 may be configured in the same manner as the display device 15. The display device 26 is an example of a display unit of the POS terminal 2.

The lamp 27 is a device capable of visually giving a notification by lighting or blinking under the control of the processing circuit 20. The lamp 27 is an example of a notification unit of the POS terminal 2.

The printing device 28 is a device for issuing a printed

matter by printing on a medium. For example, the medium is paper. For example, the printing device 28 is a thermal printer or an inkjet printer.

The sensor 29 detects a person who is present within a detection range of the sensor 29. When a person is present within the detection range, the sensor 29 detects the person and thus reacts. In this case, the sensor 29 outputs a signal indicating the detection of the person. When no person is present within the detection range, the sensor 29 does not detect a person and thus does not react. In this case, the sensor 29 does not output a signal indicating the detection of a person. For example, the detection range of the sensor 29 is the front of the POS terminal 2. The person who is present within the detection range may be a customer using the POS terminal 2. For example, the sensor 29 is a human sensor or a heat source sensor, but is not limited thereto. The sensor 29 is an example of a sensing device for detecting a person.

The hardware configuration of the POS terminal 2 is not limited to the above-mentioned configuration. The POS terminal 2 allows the above-mentioned components to be omitted or modified and new components to be added as appropriate.

Each unit realized by the processing circuit 20 will be described.

The processing circuit 20 realizes a communication processing unit 201, a registration processing unit 202, a checkout processing unit 203, a first detection unit 204, a second detection unit 205, a notification processing unit 206, an acquisition unit 207, and a setting unit 208. Each unit realized by the processing circuit 20 can also be referred to as a function. Each unit realized by the processing circuit 20 can also be referred to as being realized by a control unit including the processing circuit 20 and the main memory 21.

The communication processing unit 201 communicates with other devices via the communication interface 23.

The registration processing unit 202 processes product registration. For example, the processing of the product registration is updating of registration data. The registration data can include information on a registered product for each registered product. The information on the registered product can include information on all or some of a product code, a product name, a price, a quantity, and product sum. The product code, the product name, and the price are as described above. The quantity is the number of products identified by the product code. The product sum is the amount of money calculated by multiplying the price by the quantity. The information on the registered product may include information other than this information. The registration data may be stored in the main memory 21 or the auxiliary storage device 22 of the POS terminal 2, or may be stored in a transaction management server that manages each transaction. The updating of the registration data includes adding the information on the registered product, increasing the quantity included in the information on the registered product, decreasing the quantity included in the information on the registered product, and deleting the information on the registered product.

The checkout processing unit 203 executes checkout for a transaction based on a checkout sum. The checkout for the transaction includes completion of the checkout for the transaction. The completion of the checkout by the POS terminal 2 includes realization of the transaction.

The first detection unit 204 detects an event in the POS terminal 2. The event is an event that occurs in the POS terminal 2 in response to an input based on a customer's operation on the input device 25.

The event includes starting checkout. The start of checkout is an event that occurs in the POS terminal 2 based on a first instruction that is input in response to a customer's operation on the input device 25. The start of checkout is the start of product registration in the POS terminal 2. The first instruction is an instruction to start product registration in the POS terminal 2. For example, the first instruction is an instruction that can be input in response to pressing of a product registration start button displayed on the display device 26. For example, the first detection unit 204 can detect the start of checkout in the POS terminal 2 based on the input first instruction. The start of checkout is an example of starting processing related to a transaction in the POS terminal 2. The start of the processing related to a transaction in the POS terminal 2 is an example of a first event. The first instruction is an example of an instruction to start processing related to a transaction in the POS terminal 2. The instruction to start the processing related to a transaction in the POS terminal 2 includes the meaning of a first instruction that is input for the processing related to a transaction in the POS terminal 2.

The event includes ending checkout. The end of checkout is an event that occurs in the POS terminal 2 based on a second instruction that is input in response to a customer's operation on the input device 25. The end of checkout is the end of checkout after checkout in the POS terminal 2 has started. The second instruction is an instruction to start checkout in the POS terminal 2. For example, the second instruction is an instruction that can be input in response to pressing of a checkout button displayed on the display device 26. For example, the first detection unit 204 can detect the end of checkout in the POS terminal 2 after checkout based on the input second instruction is completed and a receipt is issued by the printing device 28. The end of checkout is an example of ending processing related to a transaction in the POS terminal 2. The end of processing related to a transaction in the POS terminal 2 is an example of a second event. The second event is an event that occurs later than the first event in time series. The second instruction is an example of an instruction to end processing related to a transaction in the POS terminal 2. The instruction to end processing related to a transaction in the POS terminal 2 includes the meaning of the last instruction that is input for processing related to a transaction in the POS terminal 2.

The second detection unit 205 detects a presence or absence result for a customer in the POS terminal 2 by using the sensor 29. The presence or absence result is the presence or absence of a customer. A customer at the POS terminal 2 is a customer who is using the POS terminal 2. The presence of a customer means that a customer is in front of the POS terminal 2. The front of the POS terminal 2 is an example of the vicinity of the POS terminal 2. The absence of a customer means that a customer is not in front of the POS terminal 2. The second detection unit 205 detects the presence of a customer at the POS terminal 2 based on the detection of a person by the sensor 29. The second detection unit 205 may set a flag indicating that a customer is in front of the POS terminal 2 based on the detection of the presence of a customer. The second detection unit 205 detects the absence of a customer at the POS terminal 2 based on the non-detection of a person by the sensor 29. The second detection unit 205 may set a flag indicating that there is no customer in front of the POS terminal 2 based on the detection of the absence of a customer.

The notification processing unit 206 controls visual notifications by the lamp 27.

The acquisition unit 207 acquires instructions or information input in response to a customer's operation on the input device 25.

The setting unit 208 changes the settings of the POS terminal 2.

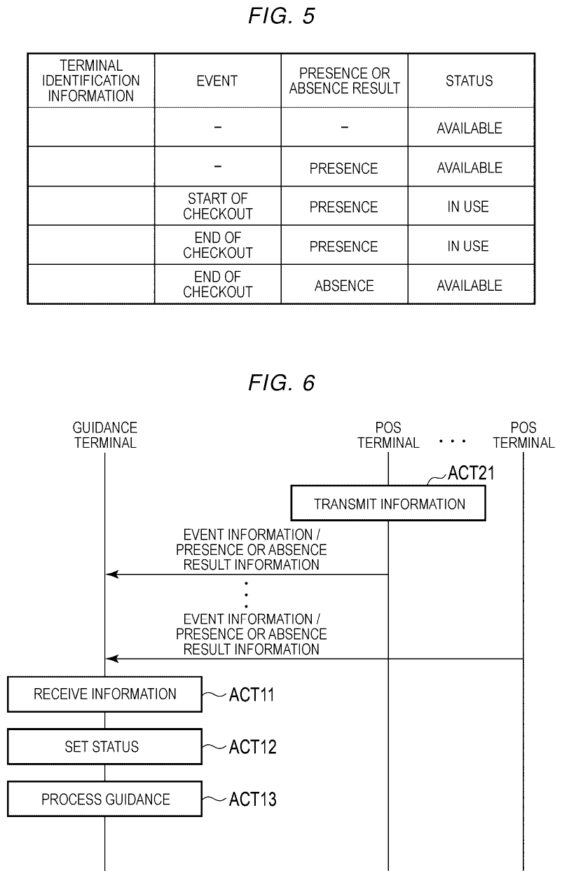

FIG. 5 is a diagram showing an example of a data structure of status data stored in the auxiliary storage device 12 of the guidance terminal 1.

The status data includes terminal identification information, event information, presence or absence result information, and status information. As described above, the terminal identification information is information for uniquely identifying the POS terminal 2.

The event information is information that indicates an event in the POS terminal 2. Here, the event information is information that indicates the start of checkout or information that indicates the end of checkout. The presence or absence result information is information that indicates a presence or absence result for a customer in the POS terminal 2 detected using the sensor 29. The presence or absence result information is information that indicates the presence of a customer or information that indicates the absence of a customer. The presence or absence result information may indicate the presence or absence of a customer by a flag. The status information is information that indicates the status in the POS terminal 2.

In the status data of the POS terminal 2, when the event is blank and the presence or absence result is blank, the status is an available state. When the event is blank and the presence or absence result indicates the presence of a customer, the status is an available state. The reason why the status is not set to an in-use state based on only a presence or absence result is that there is a possibility that the sensor 29 has detected a person simply passing in front of the POS terminal 2. When the event is the start of checkout and the presence or absence result indicates the presence of a customer, the status is an in-use state. When both conditions are met, it can be said that a customer has arrived in front of the POS terminal 2 and has started using the POS terminal 2. When the event is the end of checkout and the presence or absence result indicates the presence of a customer, the status is an in-use state. The reason why the status is not set to an available state based on only the event is that there is a possibility that a customer will not leave the front of the POS terminal 2 for a while after checkout, for example to put away his or her wallet. When the event is the end of checkout and the presence or absence result indicates the absence of a customer, the status is an available state. When both conditions are met, it can be said that the customer has finished using the POS terminal 2 and has moved away from the front of the POS terminal 2.

### Operation Example

Processing performed by a processing circuit of each device included in the information processing system SA will be described.

A processing procedure to be described below is merely an example, and each processing may be modified as much as possible. In addition, steps may be omitted, replaced, or added to the processing procedure to be described below as appropriate depending on an embodiment.

FIG. 6 is a sequence diagram showing an example of processing performed by a processing circuit of each device included in the information processing system SA.

Here, an example in which the guidance terminal 1 collects information from the plurality of POS terminals 2 is described.

The processing circuit 20 of the POS terminal 2 transmits information to the guidance terminal 1 (ACT21). ACT21 may be processing performed by the communication processing unit 201. In ACT21, for example, the processing circuit 20 transmits event information indicating a detected event to the guidance terminal 1 based on the detection of an event in the POS terminal 2. The processing circuit 20 may add information indicating the detection time of the event in the POS terminal 2 to the event information. For example, the processing circuit 20 transmits presence or absence result information indicating the detected presence or absence result based on the detection of a customer presence or absence result in the POS terminal 2 to the guidance terminal 1. The processing circuit 20 may add information indicating the detection time of the customer presence or absence result in the POS terminal 2 to the presence or absence result information.

The processing circuit 10 of the guidance terminal 1 receives information from each of the plurality of POS terminals 2 (ACT11). The processing of ACT11 may be processing performed by the communication processing unit 101. In ACT11, for example, the processing circuit 10 receives the event information from each of the plurality of POS terminals 2. The processing circuit 10 updates the event information included in status data of the POS terminal 2 to the event information received from the POS terminal 2. The processing circuit 10 receives presence or absence result information from each of the plurality of POS terminals 2. The processing circuit 10 updates the presence or absence result information included in the status data of the POS terminal 2 to the presence or absence result information received from the POS terminal 2.

The processing circuit 10 of the guidance terminal 1 sets a status based on the event information and the presence or absence result information received from each of the plurality of POS terminals 2 (ACT12). ACT12 may be processing performed by the status processing unit 102. In ACT12, for example, the processing circuit 10 sets a status for each of the plurality of POS terminals 2 based on an event in each of the plurality of POS terminals 2 and presence or absence result in each of the plurality of POS terminals 2. Here, any one POS terminal 2 included in the plurality of POS terminals 2 is described as an example.

A case where an event indicated by event information is the start of checkout and a presence or absence result indicated by presence or absence result information is the presence of a customer will be described. In this case, the processing circuit 10 sets the status in the POS terminal 2 to an in-use state based on the detection of the start of checkout and the detection of presence of a customer. When a customer uses the POS terminal 2, the customer usually starts registering products after arriving in front of the POS terminal 2. For this reason, the processing circuit 10 can set the status in the POS terminal 2 to an in-use state based on a chronological relationship between the detection timing of the start of checkout and the detection timing of presence of a customer. For example, when the detection timing of the start of checkout is later than the detection timing of presence of a customer, the processing circuit 10 sets the status in the POS terminal 2 to an in-use state. The processing circuit 10 may determine a chronological relationship between the detection timing of the start of checkout and the detection timing of presence of a customer based on the detection time of the event and the detection time of the presence or absence result.

A case where the event indicated by the event information is the end of checkout and the presence or absence result indicated by the presence or absence result information is the absence of a customer will be described. In this case, the processing circuit 10 sets the status in the POS terminal 2 to an available state based on the detection of the end of checkout and the detection of absence of a customer. When a customer finishes using the POS terminal 2, the customer usually leaves the front of the POS terminal 2 after completing the checkout. For this reason, the processing circuit 10 can set the status in the POS terminal 2 to an available state based on a chronological relationship between the detection of the end of checkout and the detection timing of absence of a customer. For example, when the detection timing of absence of a customer is later than the detection timing of the end of checkout, the processing circuit 10 sets the status in the POS terminal 2 to an available state. The processing circuit 10 may determine a chronological relationship between the detection timing of the end of checkout and the detection timing of absence of a customer based on the detection time of the event and the detection time of the presence or absence result.

The processing circuit 10 of the guidance terminal 1 performs processing for showing an available POS terminal 2 among the plurality of POS terminals 2 based on the status in each of the plurality of POS terminals 2 (ACT13). ACT13 may be processing performed by the guidance processing unit 103. In ACT13, for example, the processing circuit 10 searches for an available POS terminal 2 based on status information included in status data of each of the plurality of POS terminals 2. The processing circuit 10 performs processing for showing an available POS terminal 2 based on the searching for an available POS terminal 2.

Showing an available POS terminal 2 may be a form for guiding a customer who is waiting for any POS terminal 2 to become available to the available POS terminal 2. Showing an available POS terminal 2 may include displaying information for recognizing the available POS terminal 2 on the display device 15. In this case, for example, the processing circuit 10 performs processing for displaying a guidance screen including information for recognizing the available POS terminal 2 on the display device 15. Showing an available POS terminal 2 may include outputting information for recognizing the available POS terminal 2 by sound on a sound output device of the guidance terminal 1. For example, the information for recognizing the available POS terminal 2 is a number assigned to the available POS terminal 2. Showing the available POS terminal 2 is not limited to displaying the information for recognizing the available POS terminal 2 or outputting the information by sound. Showing the available POS terminal 2 may include displaying presence of the available POS terminal 2 or outputting it by sound. Thereby, the guidance terminal 1 can guide a customer who is waiting for any POS terminal 2 to become available to the available POS terminal 2.

The processing circuit 10 may perform processing for ending guidance to an available POS terminal 2 based on the detection of the start of checkout after the detection of the presence of a customer. The processing circuit 10 processes in this manner because there remains the possibility that the sensor 29 detected a person who simply passed in front of the POS terminal 2. By performing the processing based on the detection of the start of checkout, the processing circuit 10 can end the guiding after the customer arrives in front of the POS terminal 2 and starts using the POS terminal 2.

When the status in each of the plurality of POS terminals 2 is an in-use state, the processing circuit 10 of the guidance terminal 1 may perform processing for guiding a previous notification indicating that a POS terminal 2 will become available before showing an available POS terminal 2. The previous notification may include a message indicting that the POS terminal 2 will become available soon. The previous notification may include information for recognizing a POS terminal 2 that will become available soon, such as a number assigned to the POS terminal 2. This processing may be processing performed by the guidance processing unit 103. In this example, the processing circuit 10 can perform processing for guiding a previous notification indicating that this POS terminal 2 will become available based on the detection of end of checkout in any one POS terminal 2 among the plurality of POS terminals 2. The guiding of the previous notification may include displaying the previous notification on the display device 15. The guiding of the previous notification may include outputting the previous notification by sound by using the sound output device of the guidance terminal 1. Thereby, the guidance terminal 1 can guide the previous notification indicating that a POS terminal 2 will become available before showing an available POS terminal 2 to a customer who is waiting for any one POS terminal 2 to become available. By guiding the previous notification to the customer, the customer can immediately go toward the available POS terminal 2 when the available POS terminal 2 is shown. For this reason, the guidance terminal 1 can support the store to maintain the efficiency of checkout turnover even during peak times.

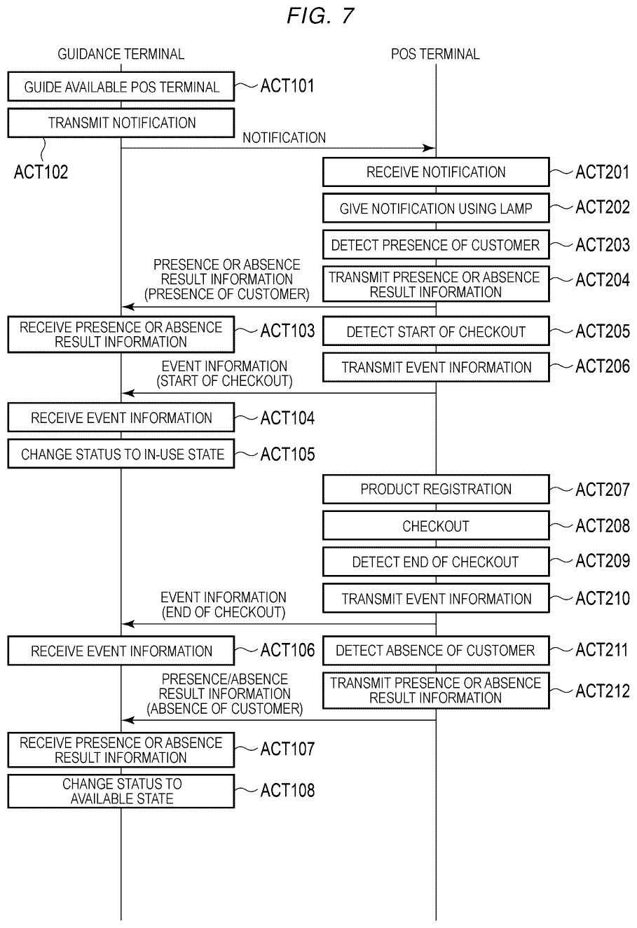

FIG. 7 is a sequence diagram showing an example of processing performed by the processing circuit of each device included in the information processing system SA.

Here, the processing of the guidance terminal 1 and the processing of the POS terminal 2 that is guided by the guidance terminal 1 as an available POS terminal 2 is described.

The processing circuit 10 of the guidance terminal 1 performs processing for showing an available POS terminal 2 among the plurality of POS terminals 2 (ACT101). The processing of ACT101 is the same as that of ACT13.

The processing circuit 10 of the guidance terminal 1 transmits a notice to the POS terminal 2 that has been guided as an available POS terminal 2 (ACT102). ACT102 may be processing performed by the communication processing unit 101. The notice is a notice for promoting a visual notification that the POS terminal 2 is the guided POS terminal 2 by the lamp 27. The notice may be a notice indicating that the POS terminal 2 is guided as an available POS terminal 2 or may be a notice for giving an instruction of a notification using the lamp 27.

The processing circuit 20 of the POS terminal 2 receives the notice from the guidance terminal 1 (ACT201). ACT201 may be processing performed by the communication processing unit 201.

The processing circuit 20 of the POS terminal 2 controls the visual notification using the lamp 27 based on the received notice (ACT202). ACT202 may be processing performed by the notification processing unit 206. In ACT202, for example, the processing circuit 20 performs control so that a visual notification indicating an available POS terminal 2 is given by turning on or blinking the lamp 27. Thereby, the POS terminal 2 can support customers waiting for any POS terminal 2 to become available so that the customers do not lose sight of the POS terminal 2 to which the customers are guided.

The processing circuit 20 of the POS terminal 2 detects the presence of a customer at the POS terminal 2 using the sensor 29 (ACT203). ACT203 may be processing performed by the second detection unit 205. When a customer arrives in front of the POS terminal 2, the processing circuit 10 detects the presence of the customer at the POS terminal 2 based on the detection of the person by the sensor 29.

The processing circuit 20 of the POS terminal 2 transmits presence or absence result information indicating the detected presence of the customer to the guidance terminal 1 based on the detection of the presence of the customer at the POS terminal 2 (ACT204). ACT204 may be processing performed by the communication processing unit 201.

The processing circuit 10 of the guidance terminal 1 receives the presence or absence result information indicating the presence of a customer from the POS terminal 2 (ACT103). The processing of ACT103 may be processing performed by the communication processing unit 101. In ACT103, for example, the processing circuit 10 updates the presence or absence result information included in the status data of the POS terminal 2 to the presence or absence result information received from the POS terminal 2 and indicating the presence of the customer.

The processing circuit 20 of the POS terminal 2 detects the start of checkout in the POS terminal 2 (ACT205). ACT205 may be processing performed by the first detection unit 204. In ACT205, for example, the processing circuit 20 detects the start of checkout in the POS terminal 2 based on a first instruction input in response to a customer's operation on the input device 25.

The processing circuit 20 of the POS terminal 2 transmits event information indicating the start of checkout to the guidance terminal 1 based on the detection of the start of checkout in the POS terminal 2 (ACT206). ACT206 may be processing performed by the communication processing unit 201.

The processing circuit 10 of the guidance terminal 1 receives the event information indicating the start of checkout from the POS terminal 2 (ACT104). The processing of ACT104 may be processing performed by the communication processing unit 101. In ACT104, for example, the processing circuit 10 updates the event information included in the status data of the POS terminal 2 to the event information indicating the start of checkout received from the POS terminal 2.

The processing circuit 10 of the guidance terminal 1 sets the status to an in-use state by changing the status in the POS terminal 2 from an available state to an in-use state (ACT105). ACT105 may be processing performed by the status processing unit 102. In ACT105, for example, the processing circuit 10 sets the status to an in-use state based on the received presence or absence result information indicating the presence of a customer and the event information indicating the start of checkout. The processing circuit 10 updates the status information included in the status data of the POS terminal 2 to status information indicating an in-use state.

The processing circuit 20 of the POS terminal 2 processes product registration (ACT207). ACT207 may be processing performed by the registration processing unit 202. In ACT207, for example, the processing circuit 20 acquires a product code of a product to be transacted based on reading of a code symbol of the product to be transacted by the scanner 24. The processing circuit 20 may acquire the product code of the product to be transacted based on selection of the product to be transacted using the input device 25. The processing circuit 20 can process the product registration based on the acquired product code with reference to product master data stored in the auxiliary storage device 22. When registration data is stored in the POS terminal 2, the processing circuit 20 updates the registration data stored in the POS terminal 2 based on the acquired product code. When the registration data is stored in the transaction management server, the processing circuit 20 outputs a registration request including the product code to the transaction management server. The registration request is a request for causing the transaction management server to process the product registration. The transaction management server can process the product registration based on the product code included in the registration request. The transaction management server may refer to data similar to the product master data stored in the POS terminal 2. Outputting the registration request including the product code to the transaction management server is an example of processing of product registration. ACT207 may be processing for reading a membership card held by a customer. In this case, the processing circuit 20 acquires membership information of the membership card based on the reading of a barcode shown on the membership card by the scanner 24.

The processing circuit 20 of the POS terminal 2 executes checkout for a transaction based on a checkout sum (ACT208). ACT208 may be processing performed by the checkout processing unit 203.

The processing circuit 20 of the POS terminal 2 detects the end of checkout in the POS terminal 2 (ACT209). ACT209 may be processing performed by the first detection unit 204. In ACT209, for example, the processing circuit 20 detects the end of checkout in the POS terminal 2 based on a second instruction input in response to a customer's operation on the input device 25.

The processing circuit 20 of the POS terminal 2 transmits event information indicating the detected end of checkout to the guidance terminal 1 based on the detection of the end of checkout in the POS terminal 2 (ACT210). ACT210 may be processing performed by the communication processing unit 201.

The processing circuit 10 of the guidance terminal 1 receives the event information indicating the end of checkout from the POS terminal 2 (ACT106). The processing of ACT106 may be processing performed by the communication processing unit 101. In ACT106, for example, the processing circuit 10 updates the event information included in the status data of the POS terminal 2 to the event information indicating the end of checkout received from the POS terminal 2.

The processing circuit 20 of the POS terminal 2 detects the absence of a customer at the POS terminal 2 using the sensor 29 (ACT211). ACT211 may be processing performed by the second detection unit 205. When a customer finishes packing purchased products and moves away from the front of the POS terminal 2, the processing circuit 10 detects the absence of a customer at the POS terminal 2 based on the sensor 29 not detecting a person.

The processing circuit 20 of the POS terminal 2 transmits presence or absence result information indicating the detected absence of a customer to the guidance terminal 1 based on the detection of absence of a customer at the POS terminal 2 (ACT212). ACT212 may be processing performed by the communication processing unit 201.

The processing circuit 10 of the guidance terminal 1 receives the presence or absence result information indicating the absence of a customer from the POS terminal 2 (ACT107). The processing of ACT107 may be processing performed by the communication processing unit 101. In ACT107, for example, the processing circuit 10 updates the presence or absence result information included in the status data of the POS terminal 2 to the presence or absence result information indicating the absence of a customer and received from the POS terminal 2.

The processing circuit 10 of the guidance terminal 1 changes the status in the POS terminal 2 from an in-use state to an available state, thereby setting the status to an available state (ACT108). ACT108 may be processing performed by the status processing unit 102. In ACT108, for example, the processing circuit 10 sets the status to an available state based on the received presence or absence result information indicating the absence of a customer and event information indicating the end of checkout. The processing circuit 10 updates the status information included in the status data of the POS terminal 2 to status information indicating an available state.

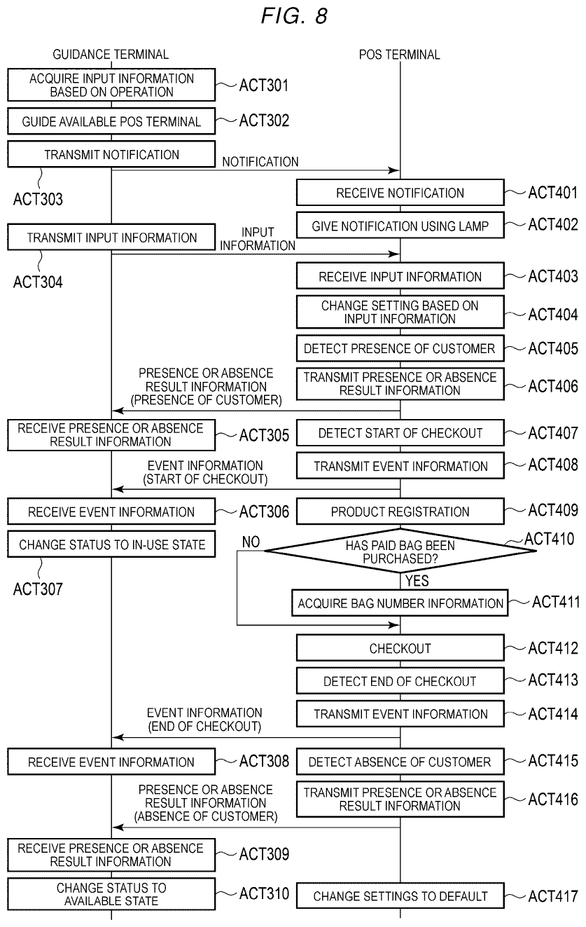

FIG. 8 is a sequence diagram showing an example of processing performed by the processing circuit of each device included in the information processing system SA.

Here, it is assumed that a customer waiting for any POS terminal 2 to become available inputs information to the guidance terminal 1 by operating the input device 14. The processing of the guidance terminal 1 and the processing of the POS terminal 2 that is guided by the guidance terminal 1 as an available POS terminal 2 will be described.

The processing circuit 10 of the guidance terminal 1 acquires input information that is input in response to a customer's operation on the input device 14 (ACT301). ACT301 may be processing performed by the acquisition unit 104. The input information is information on the settings of the POS terminal 2 which is input to the guidance terminal 1 before the operation of the POS terminal 2. The input information includes at least one of language information and paid bag information as the information on the settings of the POS terminal 2. Thereby, the customer can input the information on the settings, which is usually input in the POS terminal 2, in the guidance terminal 1 in advance.

The language information is information on the language used in the POS terminal 2. The language information includes information indicating the language used in the POS terminal 2. The language used in the POS terminal 2 is a language displayed on the display device 26 of the POS terminal 2. The language used in the POS terminal 2 may be a language that is output by sound by the sound output device of the POS terminal 2.

The paid bag information is information on the purchase of paid bags. The paid bags are plastic bags that are charged for to put purchased products in. The paid bag information includes information indicating the number of paid bags to be purchased when purchasing paid bags.

The processing circuit 10 of the guidance terminal 1 performs processing for showing an available POS terminal 2 among the plurality of POS terminals 2 (ACT302). The processing of ACT302 is the same as that of ACT101.

The processing circuit 10 of the guidance terminal 1 transmits a notice to the POS terminal 2 that has been guided as an available POS terminal 2 (ACT303). The processing of ACT303 is the same as that of ACT102.

The processing circuit 20 of the POS terminal 2 receives the notice from the guidance terminal 1 (ACT401). The processing of ACT401 is the same as that of ACT201.

The processing circuit 20 of the POS terminal 2 controls the visual notification using the lamp 27 based on the received notice (ACT402). The processing of ACT402 is the same as that of ACT202.

The processing circuit 10 of the guidance terminal 1 transmits the acquired input information to the POS terminal 2 that is guided as an available POS terminal 2 (ACT304). ACT304 may be processing performed by the communication processing unit 101.

The processing circuit 20 of the POS terminal 2 receives the input information from the guidance terminal 1 (ACT403). ACT403 may be processing performed by the communication processing unit 201.

The processing circuit 20 of the POS terminal 2 changes the settings of the POS terminal 2 based on the received input information (ACT404). ACT404 may be processing performed by the setting unit 208. In ACT404, for example, the processing circuit 20 changes the setting of a language used in the POS terminal 2 from a default Japanese to a language indicated by language information based on the language information included in the input information. The processing circuit 20 changes the setting of the number of paid bags to be purchased from a default 0 to the number indicated by the paid bag information based on the paid bag information included in the input information.

The processing circuit 20 of the POS terminal 2 detects the presence of a customer at the POS terminal 2 using the sensor 29 (ACT405). The processing of ACT405 is the same as that of ACT203.

The processing circuit 20 of the POS terminal 2 transmits presence or absence result information indicating the detected presence of the customer to the guidance terminal 1 based on the detection of the presence of the customer at the POS terminal 2 (ACT406). The processing of ACT406 is the same as that of ACT204.

The processing circuit 10 of the guidance terminal 1 receives the presence or absence result information indicating the presence of a customer from the POS terminal 2 (ACT305). The processing of ACT305 is the same as that of ACT103.

The processing circuit 20 of the POS terminal 2 detects the start of checkout in the POS terminal 2 (ACT407). The processing of ACT407 is the same as that of ACT205.

The processing circuit 20 of the POS terminal 2 transmits event information indicating the detected start of checkout to the guidance terminal 1 based on the detection of the start of checkout in the POS terminal 2 (ACT408). The processing of ACT408 is the same as that of ACT206.

The processing circuit 10 of the guidance terminal 1 receives the event information indicating the start of checkout from the POS terminal 2 (ACT306). The processing of ACT306 is the same as that of ACT104.

The processing circuit 10 of the guidance terminal 1 sets the status to an in-use state by changing the status in the POS terminal 2 from an available state to an in-use state (ACT307). The processing of ACT307 is the same as that of ACT105.

The processing circuit 20 of the POS terminal 2 processes product registration (ACT409). The processing of ACT409 is the same as that of ACT207.

When the processing circuit 20 of the POS terminal 2 acquires an instruction to purchase a paid bag which is input in response to a customer's operation on the input device 25 (ACT410, YES), the processing transitions from ACT410 to ACT411. When the processing circuit 20 does not acquire an instruction to purchase a paid bag (ACT410, NO), the processing transitions from ACT410 to ACT412. ACT410 may be processing performed by the acquisition unit 207. The instruction to purchase a paid bag is an instruction to purchase a paid bag. For example, the instruction to purchase a paid bag is an instruction that can be input in response to pressing of a paid bag purchase button displayed on the display device 26. Thereby, the customer can purchase an additional paid bag when it is necessary to add a paid bag while registering products.

The processing circuit 20 of the POS terminal 2 acquires bag number information that is input in response to a customer's operation on the input device 25 (ACT411). ACT411 may be processing performed by the acquisition unit 207. The bag number information includes information indicating the number of paid bags to be purchased.

The processing circuit 20 of the POS terminal 2 executes checkout for a transaction based on a checkout sum (ACT412). The processing of ACT412 is the same as that of ACT208. When a customer purchases a paid bag, a checkout sum includes an amount of money according to the number of paid bags purchased.

The processing circuit 20 of the POS terminal 2 detects the end of checkout in the POS terminal 2 (ACT413). The processing of ACT413 is the same as that of ACT209.

The processing circuit 20 of the POS terminal 2 transmits event information indicating the detected end of checkout to the guidance terminal 1 based on the detection of the end of checkout in the POS terminal 2 (ACT414). The processing of ACT414 is the same as that of ACT210.

The processing circuit 10 of the guidance terminal 1 receives the event information indicating the end of checkout from the POS terminal 2 (ACT308). The processing of ACT308 is the same as that of ACT106.

The processing circuit 20 of the POS terminal 2 detects the absence of a customer at the POS terminal 2 using the sensor 29 (ACT415). The processing of ACT415 is the same as that of ACT211.

The processing circuit 20 of the POS terminal 2 transmits presence or absence result information indicating the detected absence of a customer to the guidance terminal 1 based on the detection of absence of a customer at the POS terminal 2 (ACT416). The processing of ACT416 is the same as that of ACT212.

The processing circuit 10 of the guidance terminal 1 receives the presence or absence result information indicating the absence of a customer from the POS terminal 2 (ACT309). The processing of ACT309 is the same as that of ACT107.

The processing circuit 10 of the guidance terminal 1 changes the status in the POS terminal 2 from an in-use state to an available state, thereby setting the status to an available state (ACT310). ACT310 is the same as the processing of ACT108.

After transmitting the presence or absence result information indicating the absence of a customer, the processing circuit 20 of the POS terminal 2 changes the setting of the POS terminal 2 to a default (ACT417). ACT417 may be processing performed by the setting unit 208. In ACT417, for example, the processing circuit 20 changes the setting of a language used in the POS terminal 2 to a default Japanese. The processing circuit 20 changes the setting of the number of paid bags to be purchased to a default 0. Thereby, the POS terminal 2 transitions to a standby state.

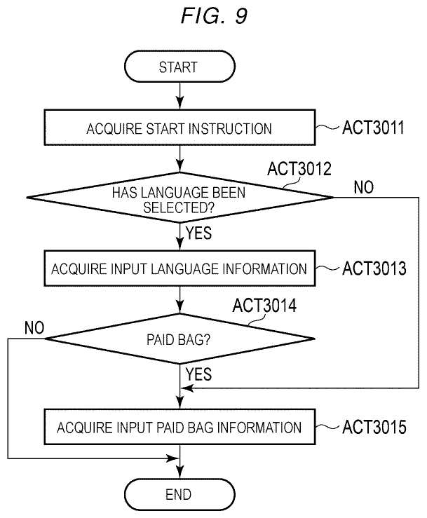

FIG. 9 is a flowchart showing an example of processing performed by the processing circuit 10 of the guidance terminal 1.

Here, the processing in ACT301 described above in which the processing circuit 10 acquires input information is described. ACT3011 to ACT3015 may be processing performed by the acquisition unit 104.

The processing circuit 10 acquires a start instruction that is input in response to a customer's operation on the input device 14 (ACT3011). The start instruction is an instruction to start inputting information to the guidance terminal 1. For example, the start instruction is an instruction that can be input in response to pressing of a start button displayed on the display device 15. The processing circuit 10 performs processing for displaying an input information selection screen on the display device 15 based on the start instruction. The input information selection screen is a screen for selecting the input of language information or the input of paid bag information. The input information selection screen can include a language selection button for selecting the input of language information and a paid bag purchase button for selecting the input of paid bag information. The language selection button can be used to input a selection instruction to input language information. The paid bag purchase button can be used to input a selection instruction to input paid bag information.

The processing circuit 10 determines whether an instruction that is input in response to a customer's operation on the input device 14 is a selection instruction to input language information (ACT3012).

When the input instruction is a selection instruction to input language information (ACT3012, YES), the processing transitions from ACT3012 to ACT3013. In this case, the processing circuit 10 performs processing for displaying a language selection screen on the display device 15 based on the selection instruction to input language information. The language selection screen is a screen for selecting a language. The language selection screen can include a plurality of language buttons for selecting a language and a language confirm button for confirming the selected language. The language buttons can be used to input a selection instruction for a language. The language confirm button can be used to input a confirmation instruction for the selected language.

When the input instruction is not a selection instruction to input language information (ACT3012, NO), the processing transitions from ACT3012 to ACT3015. When the input instruction is not a selection instruction to input language information, the input instruction is a selection instruction to input paid bag information. In this case, the language used in the POS terminal 2 is maintained as a default language. The processing circuit 10 performs processing for displaying a bag number input screen on the display device 15 based on the selection instruction to input paid bag information. The bag number input screen can include an input field for inputting the number of paid bags to be purchased and a bag number confirm button for confirming the input number of paid bags to be purchased. The bag number confirm button can be used to input a confirmation instruction for the input number of paid bags to be purchased.

The processing circuit 10 acquires language information that is input in response to a customer's operation on the input device 14 (ACT3013). In ACT3013, for example, the processing circuit 10 acquires language information indicating a selected language based on the language confirmation instruction that is input after the language selection instruction. The processing circuit 10 performs processing for displaying a paid bag purchase necessity selection screen on the display device 15 based on the language confirmation instruction. The paid bag purchase necessity selection screen is a screen for selecting whether to input paid bag information after inputting the language information. The paid bag purchase necessity selection screen can include a first selection button for selecting to input paid bag information and a second selection button for selecting not to input paid bag information. The first selection button can be used to input a selection instruction to input paid bag information. The second selection button can be used to input a selection instruction not to input paid bag information.

The processing circuit 10 determines whether the instruction that is input in response to a customer's operation on the input device 14 is a selection instruction to input paid bag information (ACT3014).

When the input instruction is a selection instruction to input paid bag information (ACT3014, YES), the processing transitions from ACT3014 to ACT3015. In this case, the processing circuit 10 performs processing for displaying the above-mentioned bag number input screen on the display device 15 based on the selection instruction to input paid bag information.

When the input instruction is not a selection instruction to input paid bag information (ACT3014, NO), the processing ends. When the input instruction is not a selection instruction to input paid bag information, the input instruction is a selection instruction not to input paid bag information.

The processing circuit 10 acquires paid bag information that is input in response to a customer's operation on the input device 14 (ACT3015). In ACT3015, for example, the processing circuit 10 acquires paid bag information indicating the input number of paid bags to be purchased, based on the confirmation instruction for the number of paid bags to be purchased which is input after the number of paid bags to be purchased is input. The processing circuit 10 ends the processing based on the confirmation instruction for the number of paid bags to be purchased.

### Display Example

Several display examples for the display device 15 of the guidance terminal 1 will be described.

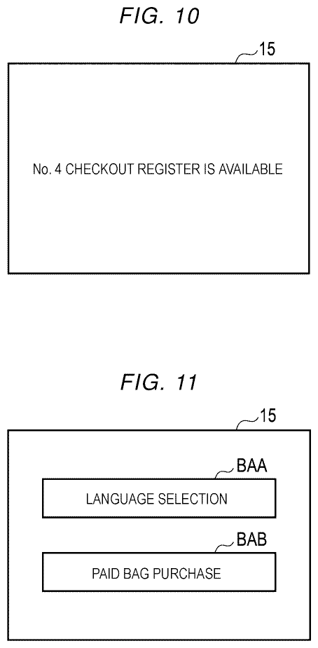

FIG. 10 is a diagram showing a display example of a guidance screen displayed on the display device 15 of the guidance terminal 1.

The guidance screen includes an expression of “No. 4” as a number assigned to an available POS terminal 2.

FIG. 11 is a diagram showing a display example of an input information selection screen displayed on the display device 15 of the guidance terminal 1.

The input information selection screen includes a language selection button BAA for selecting the input of language information and a paid bag purchase button BAB for selecting the input of paid bag information.

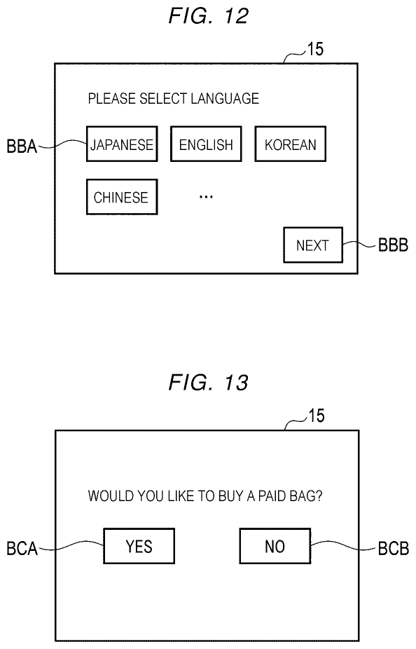

FIG. 12 is a diagram showing a display example of a language selection screen displayed on the display device 15 of the guidance terminal 1.

The language selection screen is a screen transitioned from the input information selection screen in response to pressing of the language selection button BAA on the input information selection screen shown in FIG. 11.

The language selection screen includes a plurality of language buttons BBA for selecting a language and a next button BBB. The next button BBB is a language confirm button for confirming the selected language.

FIG. 13 is a diagram showing a display example of a paid bag purchase necessity selection screen displayed on the display device 15 of the guidance terminal 1.

The paid bag purchase necessity selection screen includes a YES button BCA and a NO button BCB. The YES button BCA corresponds to a first selection button for selecting to input paid bag information. The NO button BCB corresponds to a second selection button for selecting not to input paid bag information.

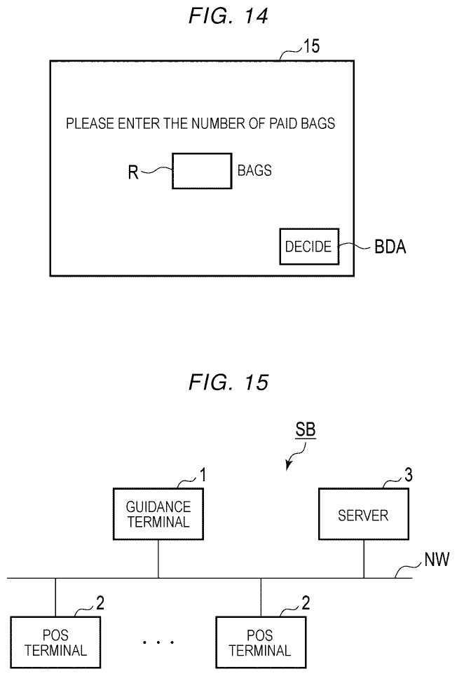

FIG. 14 is a diagram showing a display example of a bag number input screen displayed on the display device 15 of the guidance terminal 1.

The bag number input screen includes an input field R for inputting the number of paid bags to be purchased and a confirm button BDA. The confirm button BDA corresponds to a bag number confirm button for confirming the input number of paid bags to be purchased.

According to the first embodiment, the guidance terminal 1 can set the status in each of the plurality of POS terminals 2 based on an event and a presence or absence result of each of the plurality of POS terminals 2.

Thereby, the guidance terminal 1 can show an available POS terminal 2 among the plurality of POS terminals 2. The guidance terminal 1 can guide a customer who is waiting for a POS terminal 2 to become available to an available POS terminal 2 by guidance. The customer does not need to search for an available POS terminal 2 by himself or herself since he or she is only required to go toward an available POS terminal 2 by guidance. In this manner, the guidance terminal 1 can support the store to maintain the efficiency of checkout turnover even during peak times. As a result, a store attendant does not need to always be in a checkout area R, which also leads to a reduction in labor costs.

When an event is the start of checkout and a presence or absence result in the POS terminal 2 indicates the presence of a customer, the guidance terminal 1 can set the status in the POS terminal 2 to an in-use state.

Thereby, when a customer arrives in front of the POS terminal 2 and starts using the POS terminal 2, the guidance terminal 1 can set the status to an in-use state. For this reason, the guidance terminal 1 can set the status in the POS terminal 2 to an in-use state with greater accuracy than when only the sensor 29 is used.

When an event is the end of checkout and a presence or absence result in the POS terminal 2 indicates the absence of a customer, the guidance terminal 1 can set the status in the POS terminal 2 to an available state.

Thereby, the guidance terminal 1 can set the status to an available state when a customer has finished using the POS terminal 2 and is away from the front of the POS terminal 2. For this reason, the guidance terminal 1 can set the status in the POS terminal 2 to an available state with greater accuracy than when only the sensor 29 is used.

The guidance terminal 1 can transmit the input information that is input in response to an operation to the guided POS terminal 2.

Thereby, the customer can input t information on the settings of the POS terminal 2 in advance in the guidance terminal 1. For this reason, the customer can reduce a time spent in inputting the settings of the POS terminal 2 in the POS terminal 2. In this manner, the guidance terminal 1 can support the store to maintain the efficiency of checkout turnover even during peak times.

The input information includes at least one of language information and paid bag information.

Thereby, the customer can omit inputting the setting of a language in the POS terminal 2. The customer can omit inputting the number of paid bags in the POS terminal 2.

In recent years, the number of foreign tourists has been increasing, and foreign tourists may not know how to use a checkout area R and may be confused when it is crowded. Even when a foreign tourist finds an available POS terminal 2 and starts using the POS terminal 2, the POS terminal 2 displays information in Japanese. For this reason, the foreign tourist may not know how to operate the POS terminal 2 and may be confused when operating the POS terminal 2. When the foreign tourist inputs a language in advance in the guidance terminal 1, the frequency with which a store attendant assists the foreign tourist in the checkout area R will decrease.

### Second Embodiment

In a second embodiment, the processing executed by the guidance terminal described in the first embodiment is executed by a server instead of the guidance terminal.

In the second embodiment, configurations that may be similar to those in the first embodiment are denoted by the same reference numerals, and descriptions thereof will be omitted.

### Configuration Example

FIG. 15 is a block diagram showing an example of an information processing system SB.

The information processing system SB is a system that performs communication between a plurality of devices and supports transactions in a store. The information processing system SB includes one guidance terminal 1, a plurality of POS terminals 2, and a server 3. The guidance terminal 1, the plurality of POS terminals 2, and the server 3 are installed in the store. The guidance terminal 1, the plurality of POS terminals 2, and the server 3 are connected to each other via a network NW so as to be able to communicate with each other.

The server 3 is a device for showing, to a customer, an available POS terminal 2 among the plurality of POS terminals 2. The server 3 is an example of an information processing device.

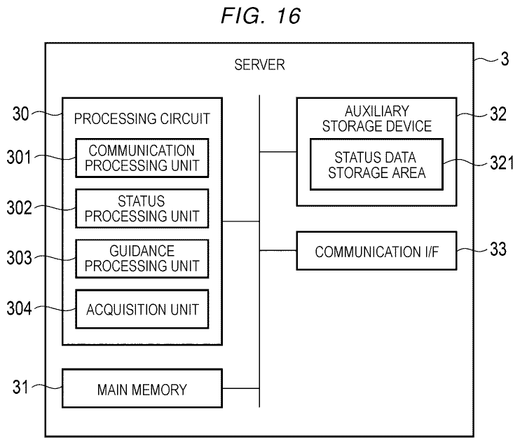

FIG. 16 is a block diagram showing the server 3.

The server 3 includes a processing circuit 30, a main memory 31, an auxiliary storage device 32, and a communication interface 33. The processing circuit 30, the main memory 31, the auxiliary storage device 32, and the communication interface 33 are connected to each other so that signals can be input and output. In FIG. 16, the interface is referred to as “I/F”.

The processing circuit 30 is equivalent to the central part of the server 3. The processing circuit 30 is an element that constitutes the computer of the server 3. The processing circuit 30 includes one or more circuits that execute a plurality of processes by a plurality of functions, similar to the processing circuit 10. The processing circuit 30 loads a program that is previously stored in the main memory 31 or the auxiliary storage device 32 into the main memory 31. The program is a program that can cause the processing circuit 30 to execute processing by each unit to be described below. The processing circuit 30 executes the program loaded into the main memory 31, thereby enabling various processes to be executed.

The main memory 31 includes elements equivalent to main memory portions of the server 3. The main memory 31 is an element that constitutes the computer of the server 3. The main memory 31 may be configured in the same manner as the main memory 11. The main memory 31 is an example of a storage unit of the server 3.

The auxiliary storage device 32 is equivalent to an auxiliary storage portion of the server 3. The auxiliary storage device 32 includes one or more storage devices, similar to the auxiliary storage device 12. The auxiliary storage device 32 is an example of a storage unit of the server 3.

The auxiliary storage device 32 includes a status data storage area 321. The status data storage area 321 stores status data of each of the plurality of POS terminals 2. Here, an example in which the auxiliary storage device 32 stores the status data of each of the plurality of POS terminals 2 will be described, but is not limited thereto. The main memory 31 may store status data of each of the plurality of POS terminals 2.

The communication interface 33 includes various interfaces that connect the server 3 to other devices via the network NW in accordance with a predetermined communication protocol. The communication interface 33 is an example of a communication unit of the server 3.

The hardware configuration of the server 3 is not limited to the above-mentioned configuration. The server 3 allows the above-mentioned components to be omitted or modified and new components to be added as appropriate.

Each unit realized by the processing circuit 30 will be described.

The processing circuit 30 realizes a communication processing unit 301, a status processing unit 302, a guidance processing unit 303, and an acquisition unit 304. Each unit realized by the processing circuit 30 can also be referred to as a function. Each unit realized by the processing circuit 30 can also be referred to as being realized by a control unit including the processing circuit 30 and the main memory 31.

The processes of the communication processing unit 301, the status processing unit 302, the guidance processing unit 303, and the acquisition unit 304 are the same as the processes of the communication processing unit 101, the status processing unit 102, the guidance processing unit 303, and the acquisition unit 304 described in the first embodiment.

### Operation Example

The processing of the processing circuit 30 is the same as the processing of the processing circuit 10 of the guidance terminal 1 described using FIGS. 6 to 9, except for the points to be described below. For this reason, in the descriptions using FIGS. 6 to 9, the “guidance terminal 1”, the “processing circuit 10”, the “communication processing unit 101”, the “status processing unit 102”, the “guidance processing unit 103”, and the “acquisition unit 104” may be read as the “server 3”, the “processing circuit 30”, the “communication processing unit 301”, the “status processing unit 302”, the “guidance processing unit 303”, and the “acquisition unit 304”.

In the description of ACT13 in FIG. 6 replaced as above, the processing performed by the processing circuit 30 of the server 3 to show a POS terminal 2 is transmitting information for showing an available POS terminal 2 in the guidance terminal 1 to the guidance terminal 1. The information for showing an available POS terminal 2 in the guidance terminal 1 may be information for recognizing an available POS terminal 2 displayed on the display device 15 of the guidance terminal 1. The information for showing an available POS terminal 2 in the guidance terminal 1 may be information that indicates the presence of an available POS terminal 2 displayed on the display device 15 of the guidance terminal 1. The information for showing an available POS terminal 2 in the guidance terminal 1 may be information that enables the user to recognize an available POS terminal 2 and that is output by a sound using a sound output device of the guidance terminal 1. The information for showing an available POS terminal 2 in the guidance terminal 1 may be information that indicates the presence of an available POS terminal 2 and that is output by a sound using the sound output device of the guidance terminal 1. Thereby, the processing circuit 10 of the guidance terminal 1 can show an available POS terminal 2 based on the information received from the server 3.

In the description of ACT301 in FIG. 8 replaced as above, acquiring input information by the processing circuit 30 of the server 3 is receiving the input information from the guidance terminal 1 via the network NW.

In the description of FIG. 9 replaced as above, acquiring instructions or information by the processing circuit 30 of the server 3 is receiving the instructions or the information from the guidance terminal 1 via the network NW. Performing processing for displaying a screen on the display device 15 by the processing circuit 30 of the server 3 is transmitting information for displaying the screen on the display device 15 to the guidance terminal 1 via the network NW. Thereby, the processing circuit 10 of the guidance terminal 1 can perform processing for displaying the screen on the display device 15 based on the information received from the server 3.

### Other Embodiments

Although the sensor 29 is described as an example of a sensing device in the above-described embodiments, this is not limiting. A camera may be used as an example of a sensing device.

Although an example in which the POS terminal 2 includes a sensing device, such as the sensor 29, has been described in the above-described embodiments, the POS terminal 2 and the sensing device may be separate bodies.

Although an example in which the processing circuit 20 of the POS terminal 2 detects a presence or absence result for a customer at the POS terminal 2 has been described in the first embodiment, this is not limiting. The processing circuit 10 of the guidance terminal 1 may realize a detection unit that detects a presence or absence result for a customer at the POS terminal 2 using the sensing device, similar to the second detection unit 205. In this example, the processing circuit 10 of the guidance terminal 1 receives a sensing result from the sensing device via the network NW. When the sensing device is the sensor 29, a sensing result is a signal indicating the detection of a person. When the sensing device is a camera, a sensing result is image data captured by the camera. The processing circuit 10 detects a presence or absence result for a customer at the POS terminal 2 based on the received sensing result.

Although an example in which the processing circuit 20 of the POS terminal 2 detects a presence or absence result for a customer at the POS terminal 2 has been described in the second embodiment, this is not limiting. The processing circuit 30 of the server 3 may realize a detection unit that detects a presence or absence result for a customer at the POS terminal 2 using the sensing device, similar to the second detection unit 205. In this example, the processing circuit 10 of the guidance terminal 1 receives the sensing result from the sensing device via the network NW. The processing circuit 30 detects a presence or absence result for a customer at the POS terminal 2 based on the received sensing result.

When the sensing device is a camera, one camera may be used to detect a presence or absence result for a customer at one POS terminal 2. One camera may be used to detect a presence or absence result for a customer at a plurality of POS terminals 2.

Although an example in which the processing circuit 20 of the POS terminal 2 transmits event information and presence or absence result information at different timings has been described in the above-described embodiments, this is not limiting. The processing circuit 20 may transmit the event information and the presence or absence result information at the same time. For example, the processing circuit 20 may transmit presence or absence result information indicating the presence of a customer and event information indicating the start of checkout based on the detection of start of checkout after detecting the presence of a customer at the POS terminal 2. The processing circuit 20 may transmit event information indicating the end of checkout and presence or absence result information indicating the absence of a customer based on the detection of absence of a customer at the POS terminal 2 after detecting the end of checkout.

Although the start of checkout has been described as an example of starting processing related to a transaction in the POS terminal 2 in the above-described embodiments, this is not limiting. Starting processing related to a transaction in the POS terminal 2 may include inputting a first instruction to start product registration in the POS terminal 2. In this case, the first detection unit 204 can detect that the first instruction has been input as a first event based on the input first instruction. The end of checkout has been described as an example of ending processing related to a transaction in the POS terminal 2, but this is not limiting. Ending processing related to a transaction in the POS terminal 2 may include inputting a second instruction to start checkout in the POS terminal 2. In this case, the first detection unit 204 can detect that the second instruction has been input as a second event based on the input second instruction.

Although the POS terminal 2 has been described as a POS terminal that allows a customer to perform product registration and checkout without the involvement of a store clerk in the above-described embodiments, this is not limiting. The POS terminal 2 may be a POS terminal in which a store clerk is involved in product registration and checkout. In this example, the store clerk operates the input device 25 of the POS terminal 2.

The POS terminal 2 may be a device separate from a terminal in which a customer performs product registration, and may be a checkout device in which a customer himself or herself can perform checkout without the involvement of a store clerk. In this example, the first event may include starting checkout in the POS terminal 2 as an example of starting processing related to a transaction in the POS terminal 2. The first event may include inputting the first instruction as an example of starting processing related to a transaction in the POS terminal 2. The first instruction may be reading a code symbol, on which a code used in checkout associated with a transaction is recorded, with the scanner 24 as an example of an instruction to start processing related to a transaction in the POS terminal 2. The first instruction may be an instruction to start checkout which is input in response to a customer's operation on the input device 25 as an example of an instruction to start processing related to a transaction in the POS terminal 2. The second event may include ending checkout in the POS terminal 2, as an example of ending processing related to a transaction in the POS terminal 2. The second event may include the input of the second instruction, example of ending processing related to a transaction in the POS terminal 2. The second instruction may be an instruction to issue a receipt, as an example of an instruction for ending processing related to a transaction in the POS terminal 2. In this case, the terminal in which the customer himself or herself performs product registration may be a dedicated terminal mounted on a shopping cart, a mobile terminal prepared in advance by a store or the like, or a mobile terminal owned by the customer himself or herself. In addition, a registration device in which a customer himself or herself performs product registration and a checkout device in which a customer himself or herself performs checkout processes may be registration devices in a system in which the devices are separate.

In addition, the POS terminal 2 may be a registration device in a system in which the registration device in which a customer himself or herself performs product registration and a checkout device in which a customer himself or herself performs a checkout process are separate. In this case, the terminal in which the customer himself or herself performs product registration may be a stationary device installed in a checkout area. In this example, the first event may include starting registration in the registration device (registration in the POS terminal 2) as an example of starting processing related to a transaction in the registration device (POS terminal 2). The first event may include inputting the first instruction as an example of starting processing related to a transaction in the registration device (POS terminal 2). The first instruction may be an instruction to start registration which is input in response to a customer's operation on the input device 25 as an example of an instruction to start processing related to a transaction in the registration device (POS terminal 2). The second event may include ending registration in the registration device (POS terminal 2) as an example of ending processing related to a transaction in the registration device (POS terminal 2). The second event may include the input of the second instruction as an example of ending processing related to a transaction in the registration device (POS terminal 2). The second instruction may be an instruction to issue a checkout receipt as an example of an instruction to end processing related to a transaction in the registration device (POS terminal 2). This checkout receipt may be a paper receipt or an electronic receipt.

The POS terminal 2 may be a device in which a store clerk performs product registration. In this case, checkout is performed by a customer himself or herself in a checkout device separate from the POS terminal 2 without the involvement of the store clerk. In this example, the first event may include starting product registration in the POS terminal 2 as an example of starting processing related to a transaction in the POS terminal 2. The first event may include inputting a first instruction as an example of starting processing related to a transaction in the POS terminal 2. The first instruction may be an instruction to start product registration in the POS terminal 2 as an example of an instruction to start processing related to a transaction in the POS terminal 2. The second event may include ending product registration in the POS terminal 2 as an example of ending processing related to a transaction in the POS terminal 2. The second event may include inputting a second instruction as an example of ending processing related to a transaction in the POS terminal 2. The second instruction may be an instruction to end product registration in the POS terminal 2 as an example of an instruction to end processing related to a transaction in the POS terminal 2.

The information processing device may be realized by one device as described by taking the guidance terminal 1 or the server 3 as an example, or may be realized by a plurality of devices with distributed functions.

The above-described embodiments may be applied to a method executed by a device. The above-described embodiments may be applied to a program capable of causing the computer of the device to execute each function. The above-described embodiments may be applied to a recording medium storing the program.

Each of one or more circuits constituting the processing circuit executes one or more processes among a plurality of processes. When the processing circuit is constituted by a single circuit, the single circuit executes all of the plurality of processes. When the processing circuit is constituted by a plurality of circuits, each of the plurality of circuits executes some of the plurality of processes. Some of the plurality of processes may be one of the plurality of processes, or may be two or more of the plurality of processes. When the processing circuit is constituted by a plurality of circuits, the plurality of circuits may be included in one device, or may be distributed to a plurality of devices.

The program may be transferred in a state of being stored in the device according to the embodiment, or may be transferred in a state of being not stored in the device. In the latter case, the program may be transferred via a network, or may be transferred in a state of being recorded on a recording medium. The recording medium is a non-transitory tangible medium. The recording medium is a computer-readable medium. The recording medium may be in any form, such as a CD-ROM or a memory card, as long as it is capable of storing the program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The above-described several embodiments described above may be expressed as follows.

[C1] An information processing device including:
a status processing unit that sets a status in each of a plurality of transaction processing devices based on an event in each of the plurality of transaction processing devices and a presence or absence result for a user in each of the plurality of transaction processing devices; and
a guidance processing unit that performs processing for showing an available transaction processing device among the plurality of transaction processing devices based on the status in each of the plurality of transaction processing devices.
   [C2] The information processing device according to [C1], wherein
when the event in the transaction processing device included in the plurality of transaction processing devices is a first event and the presence or absence result in the transaction processing device is the presence of the user, the status processing unit sets the status in the transaction processing device to an in-use state, and
when the event in the transaction processing device is a second event and the presence or absence result in the transaction processing device is the absence of a user, the status processing unit sets the status in the transaction processing device to an available state.
   [C3] The information processing device according to [C1], further including:
an acquisition unit that acquires input information that is input in response to an operation; and
a communication processing unit that transmits the input information to the shown transaction processing device.
   [C4] The information processing device according to [C3], wherein the input information includes at least one of information on a language used in the transaction processing device and information on purchase of a paid bag.
   [C5] An information processing system including:
a plurality of POS terminals; and
an information processing device that includes
a status processing unit that sets a status in each of a plurality of transaction processing devices based on an event in each of the plurality of transaction processing devices and a presence or absence result for a user in each of the plurality of transaction processing devices, and
a guidance processing unit that performs processing for showing an available transaction processing device among the plurality of transaction processing devices based on the status in each of the plurality of transaction processing devices.
   [C6] A method capable of causing a computer to execute:
setting a status in each of a plurality of transaction processing devices based on an event in each of the plurality of transaction processing devices and a presence or absence result for a user in each of the plurality of transaction processing devices; and
performing processing for showing an available transaction processing device among the plurality of transaction processing devices based on the status in each of the plurality of transaction processing devices.

What is claimed is:

1. An information processing device, comprising:
a status processing component configured to set a status in each of a plurality of transaction processing devices based on an event in each of the plurality of transaction processing devices and a presence or absence result for a user in each of the plurality of transaction processing devices; and
a guidance processing component configured to perform processing for showing an available transaction processing device among the plurality of transaction processing devices based on the status in each of the plurality of transaction processing devices.

2. The information processing device according to claim 1, wherein
when the event in the transaction processing device included in the plurality of transaction processing devices is a first event and the presence or absence result in the transaction processing device is a presence of a user, the status processing component sets the status in the transaction processing device to an in-use state, and
when the event in the transaction processing device is a second event and the presence or absence result in the transaction processing device is an absence of a user, the status processing component sets the status in the transaction processing device to an available state.

3. The information processing device according to claim 1, further comprising:
an acquisition component configured to acquire input information that is input in response to an operation; and
a communication processing component configured to transmit the input information to the shown available transaction processing device.

4. The information processing device according to claim 3, wherein the input information includes at least one of information on a language used in the transaction processing device and information on purchase of a paid bag.

5. The information processing device according to claim 1, wherein the guidance processing component is one of a smartphone, a tablet terminal, or a personal computer.

6. The information processing device according to claim 1, wherein the event is information that indicates a start of a user checkout procedure or information that indicates the end of the user checkout procedure.

7. An information processing system, comprising:
a plurality of POS terminals; and
an information processing device comprising
a status processing component configured to set a status in each of a plurality of transaction processing devices based on an event in each of the plurality of transaction processing devices and a presence or absence result for a user in each of the plurality of transaction processing devices, and
a guidance processing component configured to perform processing for showing an available transaction processing device among the plurality of transaction processing devices based on the status in each of the plurality of transaction processing devices.

8. The information processing system according to claim 7, wherein the plurality of POS terminals are self-service POS terminals.

9. The information processing system according to claim 7, wherein each of the plurality of POS terminals comprises a lamp configured to visually notify the status of a presence or absence result.

10. The information processing system according to claim 7, wherein
when the event in the transaction processing device included in the plurality of transaction processing devices is a first event and the presence or absence result in the transaction processing device is a presence of a user, the status processing component sets the status in the transaction processing device to an in-use state, and
when the event in the transaction processing device is a second event and the presence or absence result in the transaction processing device is an absence of a user, the status processing component sets the status in the transaction processing device to an available state.

11. The information processing system according to claim 7, further comprising:
an acquisition component configured to acquire input information that is input in response to an operation; and
a communication processing component configured to transmit the input information to the shown available transaction processing device.

12. The information processing system according to claim 11, wherein the input information includes at least one of information on a language used in the transaction processing device and information on purchase of a paid bag.

13. The information processing system according to claim 7, wherein the guidance processing component is one of a smartphone, a tablet terminal, or a personal computer.

14. The information processing system according to claim 7, wherein the event is information that indicates a start of a checkout procedure or information that indicates the end of the user checkout procedure.

15. An information processing method, comprising:
setting a status in each of a plurality of transaction processing devices based on an event in each of the plurality of transaction processing devices and a presence or absence result for a user in each of the plurality of transaction processing devices; and
performing processing for showing an available transaction processing device among the plurality of transaction processing devices based on the status in each of the plurality of transaction processing devices.

16. The information processing method according to claim 15, further comprising:
when the event in the transaction processing device included in the plurality of transaction processing devices is a first event and the presence or absence result in the transaction processing device is a presence of a user, setting the status in the transaction processing device to an in-use state, and
when the event in the transaction processing device is a second event and the presence or absence result in the transaction processing device is an absence of a user, setting the status in the transaction processing device to an available state.

17. The information processing method according to claim 15, further comprising:
acquiring input information that is input in response to an operation; and
transmitting the input information to the shown available transaction processing device.

18. The information processing method according to claim 17, wherein the input information includes at least one of information on a language used in the transaction processing device and information on purchase of a paid bag.

19. The information processing method according to claim 15, wherein the guidance processing component is one of a smartphone, a tablet terminal, or a personal computer.

20. The information processing method according to claim 15, wherein the event is information that indicates a start of a user checkout procedure or information that indicates the end of the user checkout procedure.
